(19) United States
(12) Patent Application Publication
(10) Pub. No.: US 2010/0005004 A1
(43) Pub. Date: Jan. 7, 2010

(54) System and method to guarantee a selling price of a product

(76) Inventors: William Hudak, Palo Alto, CA (US); Jordan Kobert, San Francisco, CA (US); David Keefer, Menlo Park, CA (US)

Correspondence Address: Jordan Kobert, 262 Frederick St., #1, San Francisco, CA, 94117, US

(21) Appl. No.: 12/459,302

(22) Filed: Jun. 30, 2009

Related U.S. Application Data
(60) Provisional application No. 61/076,995, filed on Jun. 30, 2008.

(51) Int. Cl. G06Q 40/00; G06Q 30/00

(52) U.S. Cl. 705/26; 705/400; 705/39

(57) ABSTRACT

A preferred method for providing a guarantee for a value of product includes the steps of receiving product information, generating a product value based on the received product information, and providing a guarantee that a user will receive a payment for a product, the payment having a value at least equal to the generated product value. A preferred system for generating a product value includes a user interface adapted and configured to receive product information; a processor coupled to the user interface, wherein the processor is adapted and configured to generate a product value based on the product information received by the user interface; and a payment having a value at least equal to the product value. The system and method are preferably designed for the ecommerce field and, more specifically, for guaranteeing a selling price of a product in the ecommerce field.

### CROSS-REFERENCE TO RELATED APPLICATIONS

This application claims priority to U.S. Provisional Application No. 61/076,995, titled “SYSTEM AND METHOD TO GUARANTEE A SELLING PRICE OF A PRODUCT” filed Jun. 30, 2008, which is incorporated by reference herein in its entirety.

In addition, the systems and methods described herein may be applied to any of the devices and systems described in any of the following references. This application may be related to U.S. application Ser. No. 11/682,278, titled “System and Method for Enabling Online Research, Publication, Promotion, and Management of User Goods”, and filed 5 Mar. 2007. This application may also be related to U.S. Provisional Application No. ______, titled “System and Method to Guarantee A Selling Price of a Product”, filed 7 Apr. 2009; and to U.S. application Ser. No. ______, titled “Systems and Methods to Generate a Product Value”, filed 1 May 2009. Each of these applications is incorporated by reference herein in its entirety.

### INCORPORATION BY REFERENCE

All publications and patent applications mentioned in this specification are herein incorporated by reference in their entirety as if each individual publication or patent application was specifically and individually indicated to be incorporated by reference.

### TECHNICAL FIELD

This invention relates generally to the ecommerce field, and more specifically to an improved method and system to guarantee a selling price of a product in the ecommerce field.

### BRIEF DESCRIPTION OF THE FIGURES

FIG. 1 is a flow diagram of the system and method of a preferred embodiment of the invention.

FIG. 2 is a flow diagram of the step of receiving product information of the system and method of a preferred embodiment of the invention.

FIGS. 3A-3C are drawings of the system of a preferred embodiment of the invention.

FIGS. 4 and 5 are flow diagrams of the system and method of a preferred embodiment of the invention.

### DESCRIPTION OF THE PREFERRED EMBODIMENTS

The following description of preferred embodiments of the invention is not intended to limit the invention to these embodiments, but rather to enable any person skilled in the art to make and use this invention.

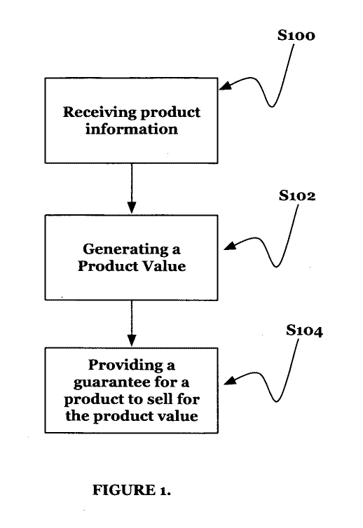

As shown in FIG. 1, the system and method of the preferred embodiments includes the steps of receiving product information S100, generating a product value S102, and providing a guarantee for the product to sell for the product value S104. The system and method are preferably designed for the ecommerce field and, more specifically, for guaranteeing a selling price of a product in the ecommerce field. The system, however, may be alternatively used in any suitable environment and for any suitable reason.

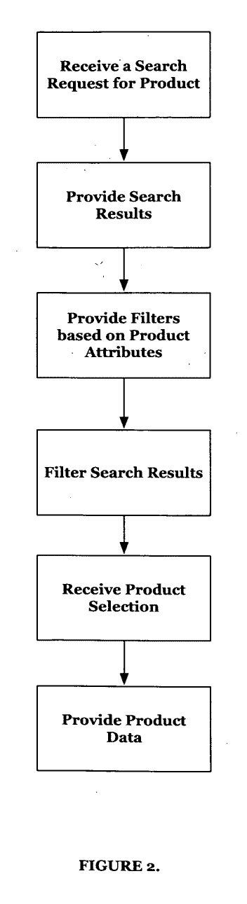

The step of receiving product information S100 functions to indicate to the system, the product for which the system will generate a product value and for which the user wishes to obtain a guarantee. The product information may be received by a processor such as a server or internet website. The product information may be received by a user interface such as a cell phone, a webpage, a computer, or other suitable interface that is coupled to the processor. The website may be a merchant, a marketplace, or other suitable website that provides and/or receives product data. The product information is preferably received in one of several variations. In a first variation, as shown in FIG. 2, the step of receiving product information S100 includes any suitable combination of the steps of receiving a search request for a product, providing search results, providing filters based on product attributes, receiving filtered search results, receiving a product selection, and providing product data. The step of receiving a search request for a product includes the steps of receiving a product description into a search bar and receiving a search request. For example, a user preferably enters keywords (such as specific product attributes) for a product for which they wish to search (and preferably eventually purchase, sell, etc.) and then initiates the search. The user may alternatively enter categories and subcategories to “narrow in” on the desired product. The step of providing search results preferably includes the step of providing a list of relevant products along with a photo of the product and a brief description and/or title of the product. The search results may be filtered based on the attributes of the products. Product attributes preferably include brand, model, size, storage capacity, mega pixels, or any other suitable attribute. A user may select a specific product from the list of search results. The system preferably provides product data on this product such as average price, price of the item when new, where to buy the buy product, where to buy the item on internet marketplaces such as eBay, product specifications, product reviews, the values of other users' similar products, and/or any other suitable information.

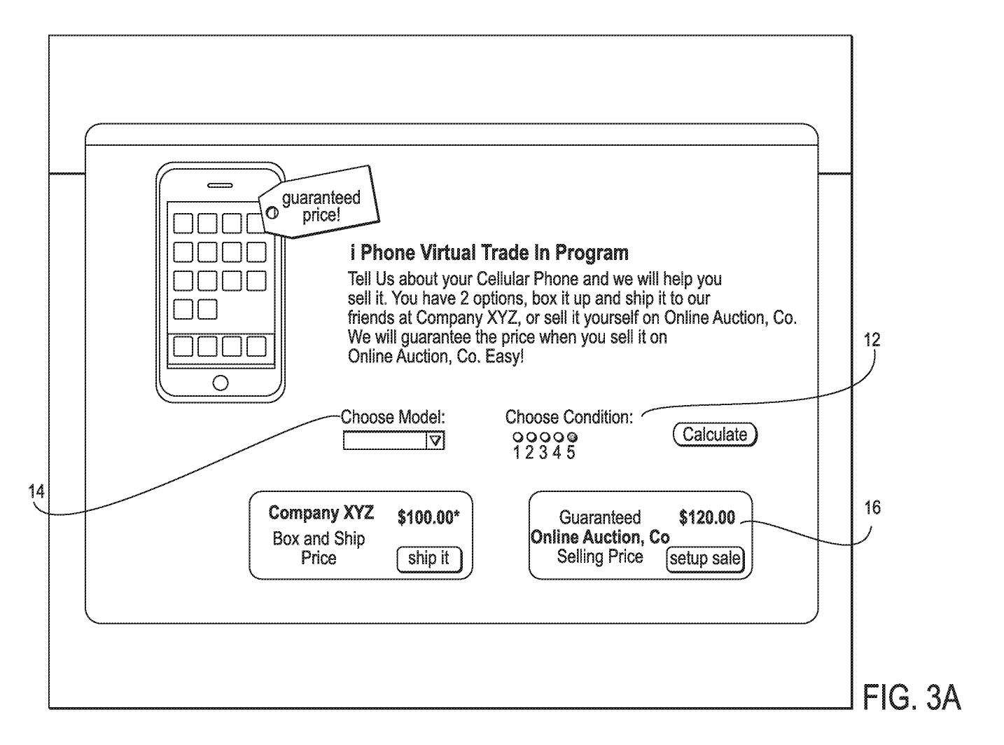

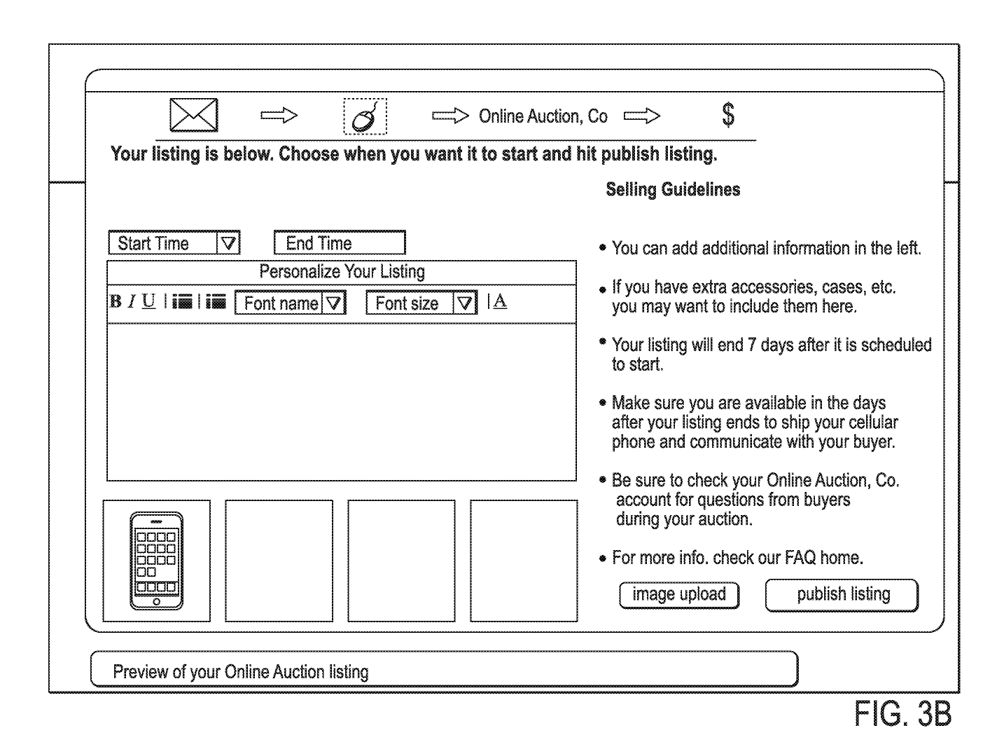

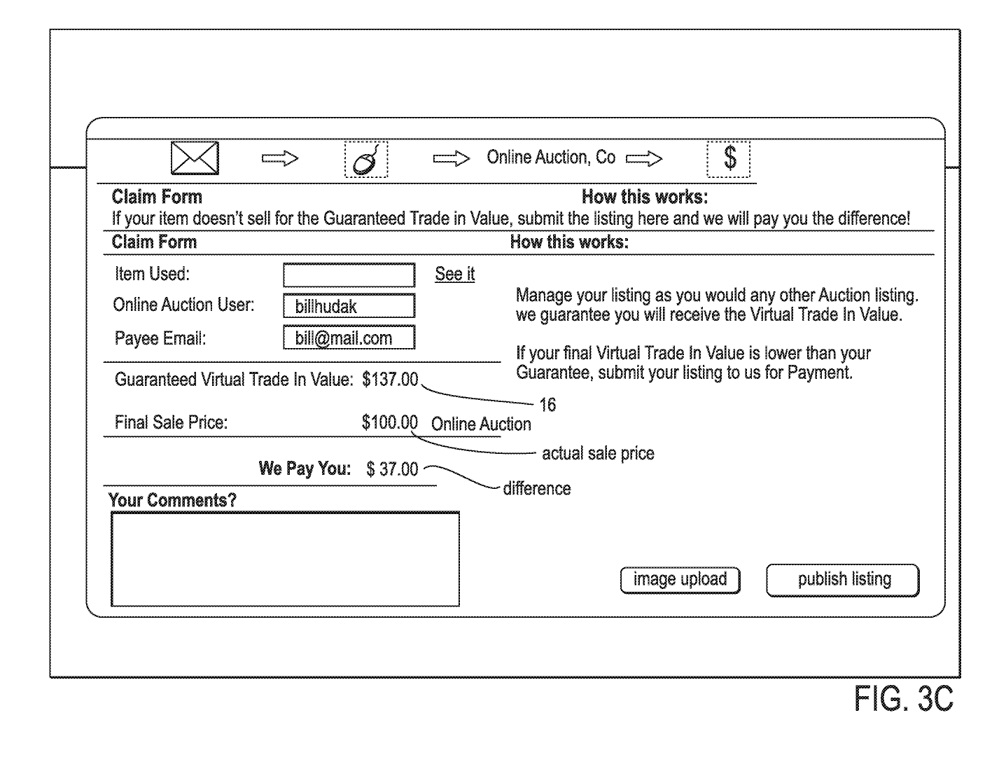

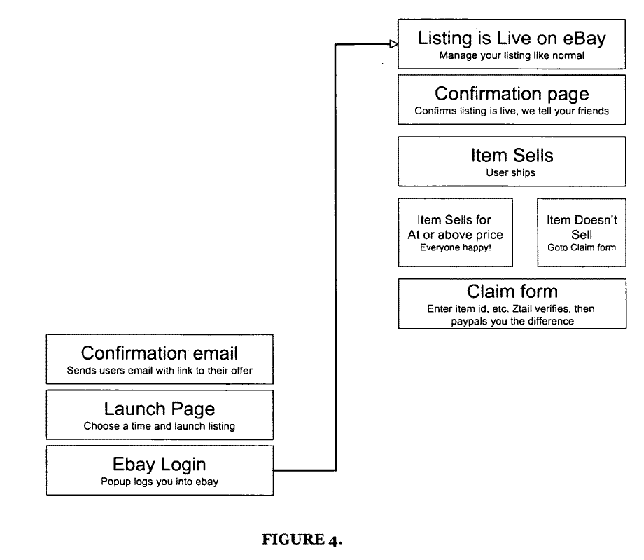

In a second variation, the step of receiving product information S100 is completed by a user entering information on the product directly or may be completed by a user customizing a product selected from the product search results. The user may enter the product information into the system via a cellular phone, a smart phone, a computer, an internet webpage, and internet email, or through any other suitable mechanism. The information may then be sent to a processor such as a server or website. The step of receiving product information S100 preferably includes the steps of receiving the title of the product, receiving the specified condition of the product, receiving a description of the product, and/or receiving uploaded photos of the product. As shown in FIG. 3A, the step of receiving the specified the condition of the product preferably includes the step of a user giving a rating on a scale of 1 to 5, but may alternatively include any other suitable means of specifying the condition 12 of the product. For example, a product in poor condition with a broken screen and several scratches may be given a 1 while a product that is new or just out of the box and as good as new might be given a 5. The step of receiving a description of the product includes receiving information on the model 14 of the product (as shown in FIG. 3A), the condition of the product, accessories or extras included with the product, length of use of product, age of product, and/or any other suitable information on the product.

The step of generating a product value S102, functions to provide a value for which the system and method will provide the guarantee. The product value is preferably generated by the processor that received the product information. The product value is preferably generated by the processor following an algorithm as described below. The product value is preferably generated in one of several variations. In a first variation, the step of generating a product value S102 preferably includes the steps of receiving information from multiple sources, removing outlying values, assigning weights to values, generating an average value, and generating a product value S102. Multiple sources from which information is received preferably include user estimated values, marketplace listings (such as Ebay, Amazon, or Craigslist), retailer or manufacturers, or any other suitable source of information. The step of removing outlying values functions to remove unreasonable and/or incorrect values from the information gathered from at least one source before they are included in the generation of the product value. An outlying value is a value that is either too low or too high to be included in the generation of the product value. The step of assigning weights to values functions to differentiate between different values received from the information gathered from at least one source and to assign a higher weight to some values and a lower weight to other values. For example, a higher weight may be assigned to a value that is considered more reasonable and/or reliable, as defined by the system or a third party based on the source of the value or the value itself. Alternatively, the higher weight may be assigned to a value that is considered better, more important, more accurate, more precise, or any other suitable measure. Values assigned a higher weight will play a larger role in the generation of the product value than a value that has been assigned a lower weight. Once the outliers have been removed and the weightings have been assigned, an average value is generated taking into account all (or any suitable combination) of the considerations described above. Each of the weighted average values are then preferably combined in any suitable fashion to generate the product value. The first variation of the step of generating a product value S102 preferably generates a value for the product for which the system will provide the guarantee, but may alternatively be performed for a similar product or for a product in a similar product category or for any other suitable product.

Although the step of generating a product value S102 is preferably completed using any suitable combination of steps as described above, the product value 16 (as shown in FIG. 3A) may alternatively be generated using a fixed value for a given product, using a fixed value for a given product in a given condition, using a percentage of a new value for a given product, using a percentage of any other suitable value for a given product, or any other suitable number, percentage, or value. Additionally, the user may determine the product value directly.

The step of providing a guarantee for the product to sell for the product value S104 (herein “providing a guarantee”), functions to guarantee that when the product is sold a user will receive, through at least one paying mechanism, an amount of money (or some other item having a value) that is of equal or greater value than the generated product value. Alternatively, rather than being sold, the product may be returned, given, or otherwise relinquished by the user to the system or a third party, etc. in order to receive at least the generated product value. The user will receive at least the generated product value in one of several variations including (a) a user obtaining an actual sale price from a buyer or third party (i.e. selling the product to a buyer or third party for an amount of money) that is equal to or greater than the generated product value or (b) a user obtaining an actual sale price that is less than the generated product value, and receiving from the system (or third party) the difference between the generated product value and the actual sale price.

A user may purchase this guarantee, but may alternatively obtain the guarantee in any other suitable fashion. The user may purchase this guarantee by paying a fixed price, a percentage of the product value, a percentage of the actual sale price, or any other suitable price. The guarantee is preferably granted for the generated product value that has been provided by the system. However, a user may purchase a guarantee for any suitable price based on any suitable value for the product, generated by any suitable system and/or generated or chosen by the user. The user may alternatively obtain the guarantee by buying a product. The product may be the product for which the system has generated the product value or may be a next generation product or a competitive product. The user may alternatively obtain the guarantee by performing any other suitable action such as subscribing to a system or network, selling a product, etc.

Once the user has obtained the guarantee for their product to sell at the generated product value, and the product is sold for an actual sale price, the user will receive the difference between the generated product value and the actual sale price if the actual sale price is less than the generated product value. For example, as shown in FIG. 3A, a user is selling a cellular phone, more specifically an iphone, the generated product value 16 is $120.00 (as shown in FIG. 3A), and the user has obtained the guarantee for their product to sell for the product value of $120. In this example, if the user sells their cellular phone for an actual selling price of $105.00. The user will receive, from the system or a third party, the difference between the generated product value 16 and the actual sale price, which is $15.00 ($120.00-$105.00=$15.00). In some situations it is possible that the user will sell their cellular phone for the actual selling price of $105.00 but the buyer of the product does not or refuses to pay the user the full actual selling price. In this situation, the system will preferably provide the difference between the generated product value and the actual sale price ($15.00), independent of the amount of money that the buyer actually pays the user. Alternatively, the system may provide the difference between the generated product value and the actual amount of money that the user receives. For example, if the user sells the cellular phone for the actual sale price of $105.00, but the buyer does not actually pay the user, the system may provide the difference between the generated product value and the amount of money that the user actually receives ($0.00). In this example, this difference is $120.00 ($120.00−$0.00=$120.00).

Alternatively, the user may receive the generated product value directly from the system or a third party upon relinquishing their product to the system or a third party. In some instances, the user may receive the generated product value regardless of whether or not the product is sold and/or regardless of what the actual sale price is if the product is sold.

The guarantee may include conditions that must be met in order for the user to receive the difference between the generated product value and the actual sale price. The conditions preferably include any suitable combination of conditions including specifying where the listing for the product is created, where the listing for the product is published, when and for how long the listing for the product is active, when the guarantee will expire, or any other suitable conditions.

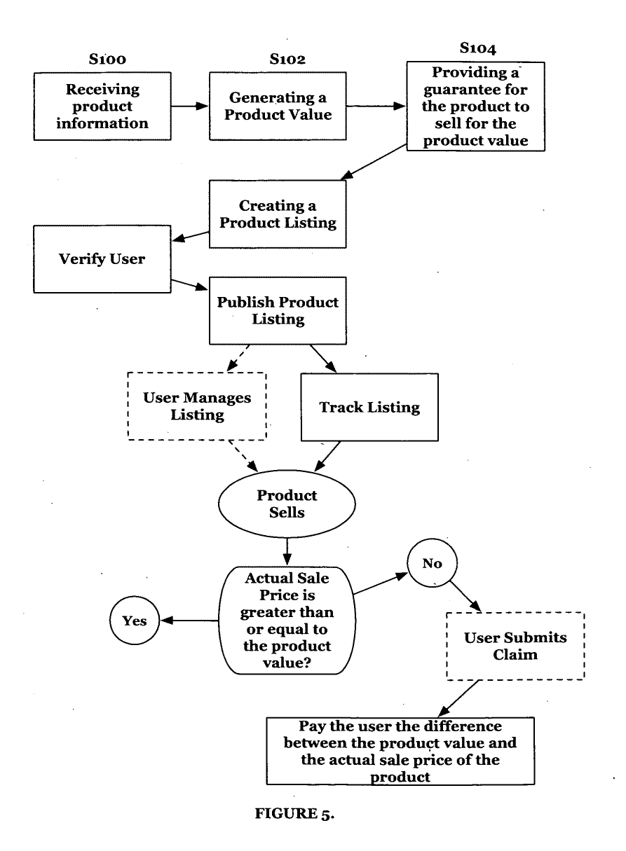

As shown in FIG. 5, the system and method of the preferred embodiments may also include any suitable combination of the steps of creating a product listing, verifying a user identity, tracking the product listing, a user monitoring the product listing, promoting a product listing (not shown), a user submitting a claim, and paying the difference between the product value and the actual sale price of the product. As shown in FIG. 3B, the step of creating a product listing functions to allow a user to sell their product by way of the product listing. The system may provide a mechanism through which a user creates a product listing with which to sell their item in a marketplace, such as eBay, Craig's List, or in any other suitable system or location. The product listing is may be created using the received information on the product, such as model, condition, accessories, etc.

The step of verifying a user identity may be performed by (a) requiring a user to log into a system, (b) sending the user an email and requiring that they use a link within the email to access their product listing, and/or (c) through any other suitable mechanism. When the user accesses their product listing (e.g. via a link in an email received from the system), the user is preferably able to edit and preview their listing. The user may edit and preview their listing at any other suitable time through any other suitable mechanism. Alternatively, the product listing may be automatically created by the system and/or the user may have limited or no access to the product listing.

As shown in FIG. 5, once the product listing has been created and the identity of the user has been verified, the product listing is published. The product listing is preferably published to a marketplace, such as eBay, but may alternatively be published in any other suitable location. Once created and verified, the product listing is preferably published by the system to the external marketplace, but alternatively, the product listing may be created externally, the identity of the user may not be verified, and/or the product listing may be published by a separate and/or external system.

As shown in FIG. 5, once the product listing is published the system may then perform the step of tracking the product listing, particularly while the sale is pending, once the sale has ended, and/or once the product is sold. In some variations, a user may have the opportunity to monitor the product listing while the sale is pending, once the sale has ended, and/or once the product is sold. The system preferably tracks the system through an application program interface (API), but may alternatively track the product listing through any other suitable mechanism. The system preferably tracks the listing and monitors information such as time remaining for the listing, current sale price of the product, number of bids on the products, actual sale price of the product, and/or any other suitable information. The user preferably monitors the product listing according to the marketplace with which the product listing is published, but may alternatively monitor the product listing in any other suitable fashion. Alternatively, the user may fail to publish the listing and/or may fail to monitor the listing once the product listing is published.

The step of promoting a product listing, functions to increase traffic to the published listing and preferably functions to increase the actual sale price of the product. The system preferably promotes the product listing by generating a widget or advertisement that can be published to external sites. The promotion on the external site is preferably an e-mail, a widget, or any other suitable promotion on any suitable external site. The external site is preferably a blog, social networking page such as Facebook, MySpace, Twitter, and/or Bebo, a classifieds site such as Craigslist, or any other suitable external site. Alternatively, the published product listing can be promoted in any other suitable fashion.

As shown in FIG. 5, the product will preferably be sold through the product listing. The product will sell for an “actual sale price”. If the actual sale price is greater than or equal to the price at which the guarantee was applied (preferably the generated product value), then the user preferably receives the actual sale price from the buyer of the product, according to the rules, conditions, and/or specifications of marketplace with which the product listing is published. The user may alternatively receive the actual sale price (or any portion thereof or nothing) in any other suitable fashion. As shown in FIG. 5, if the actual sale price is less than the price for which the guarantee was applied (i.e. the generated product value), then the user preferably receives the actual sale price, as described above, and additionally has the opportunity to receive the difference between the price at which the guarantee was applied (preferably the generated product value) and the actual sale price, which sums to the generated product value.

As shown in FIG. 5, if the actual sale price is less than the price for which the guarantee was applied then, in some variations, the step of a user submitting a claim may be performed. As shown in FIG. 3C, this step functions to submit a request to the system for a payment of the difference between the price at which the guarantee was applied (preferably the generated product value) and the actual sale price, which sums to the generated product value. Preferably, the payment will only be sent if the user meets the conditions of the guarantee as described above and/or if the system has received a claim for the payment. Alternatively, if the actual sale price is less than the price at which the guarantee was applied the system may automatically send a payment (with or without the user submitting a claim for the guarantee) upon the sale of the product and/or upon the close of the product listing for the amount of the difference between the price at which the guarantee was applied and the actual sale price. The system preferably sends the payment through any suitable system that allows payments and money transfers to be made through the Internet, such as Paypal, but may alternatively send a check, money order, add money to a credit card, provide credit or a gift certificate, or send the payment through any other suitable method.

Although omitted for conciseness, the preferred embodiments include every combination and permutation of the various steps of receiving product information S100, generating a product value S102, and providing a guarantee for a product to sell for that product value.

As a person skilled in the art will recognize from the previous detailed description and from the figures and claims, modifications and changes can be made to the preferred embodiments of the invention without departing from the scope of this invention defined in the following claims.

We claim:

1. A method for providing a guarantee for a value of product, the method comprising:
receiving product information;
generating a product value based on the received product information; and
providing a guarantee that a user will receive a payment for a product, the payment having a value at least equal to the generated product value.

2. The method of claim 1, the receiving step comprising receiving a product value request from a user by the user selecting a product from a list of search results.

3. The method of claim 1, the receiving step comprising receiving the condition of the product.

4. The method of claim 3, the receiving step further comprising a rating of the condition of the product as determined by a user.

5. The method of claim 1, the generating step comprising accumulating product value information.

6. The method of claim 5, the accumulating step comprising receiving a value from an external site.

7. The method of claim 1, the generating step further comprising generating a product value by selecting a fixed value for a given product.

8. The method of claim 7, the generating step further comprising generating a product value by selecting a fixed value for a given product in a given condition.

9. The method of claim 1, the generating step further comprising generating a product value by calculating a percentage of the market value of the given product.

10. The method of claim 1, the generating step further comprising receiving the product value as an input from a user.

11. The method of claim 1, the providing step comprising providing a payment having a value equal to the difference between the generated product value and an actual sale price, wherein a user sells a product for the actual sale price and the actual sale price is less than the generated product value.

12. The method of claim 1, the providing step comprising providing a supplemental payment having a value equal to the difference between the generated product value and a payment received by a user in exchange for a product if the payment is less than the generated product value.

13. The method of claim 1, the providing step comprising providing a payment having a value equal to the generated product value.

14. The method of claim 1, further comprising the step of receiving a payment from a user for the guarantee.

15. The method of claim 1, the providing step further comprising providing a guarantee to a user for a given product, wherein the user has purchased a specified product.

16. The method of claim 1, further comprising the step of creating a product listing and publishing the product listing to a marketplace.

17. The method of claim 16, further comprising the step of receiving an actual sale price for the product.

18. The method of claim 17, further comprising providing a payment having a value equal to the difference between the generated product value and the actual sale price if the generated product value is greater than the actual sale price.

19. The method of claim 1, the providing step comprising providing a payment in the form of at least one of a money transfer, a check, a money order, credit, and a gift certificate.

20. A system for generating a product value, the method comprising:
a user interface adapted and configured to receive product information;
a processor coupled to the user interface, wherein the processor is adapted and configured to generate a product value based on the product information received by the user interface; and
a payment having a value at least equal to the product value.
